(19) United States
(12) Patent Application Publication
(10) Pub. No.: US 2025/0350576 A1
(43) Pub. Date: Nov. 13, 2025

(54) Identity Management Service Providing Anonymized Email Addresses

(71) Applicant: Apple Inc., Cupertino, CA (US)

(72) Inventors: Gianpaolo Fasoli, Redwood City, CA (US); Evan C. Krasts, Burlingame, CA (US); Rahul K. Zingde, San Jose, CA (US); Leger Nicholas Mottin Brosnahan, JR., Sunnyvale, CA (US); Sudhakar N. Mambakkam, Saratoga, CA (US); Dmitry V. Belov, Santa Clara, CA (US); Graham S. Orndorff, Aptos, CA (US); Gokul P. Thirumalai, Mountain View, CA (US)

(73) Assignee: Apple Inc., Cupertino, CA (US)

(21) Appl. No.: 19/277,834

(22) Filed: Jul. 23, 2025

Related U.S. Application Data
(63) Continuation-in-part of application No. 16/888,461, filed on May 29, 2020.
(60) Provisional application No. 62/856,049, filed on Jun. 1, 2019.

(51) Int. Cl. H04L 51/48; H04L 51/212

(52) U.S. Cl. CPC H04L 51/48; H04L 51/212

(57) ABSTRACT

A method and apparatus of a device that forwards an email from a developer or provider of an application or service to a user is described. In an exemplary embodiment, the device receives an email, where the email includes a provider email address associated with the provider, the provider email address is a “from” email address, an anonymized user email address associated with a user, wherein the anonymized user email address is a “to” email address. The device further extracts an anonymous user identifier from the anonymized user email address and the device determines a provider identifier using at least the anonymous user identifier. In addition, the device determines one or more replacement email addresses and forwards the email using the one or more replacement email addresses.

This application is a Continuation-in-part of U.S. patent application Ser. No. 16/888,461, filed on May 29, 2020, which claims the benefit of priority of U.S. Provisional Patent Application No. 62/856,049, filed on Jun. 1, 2019, which are incorporated herein by reference in their entirety to provide continuity of disclosure.

### FIELD OF INVENTION

This invention relates generally to email processing and more particularly to an anonymous email relay.

### BACKGROUND OF THE INVENTION

A single sign-on service is a service that allows a user to use a single set of credentials to sign-on to multiple services across one or more authorization domains. For example, a user could use a single username and password combination (or another set of user credentials) to sign-on for media streaming service from one company and a social media account from another company, even though these two companies are in different authorization domains. In this embodiment, having a single sign-on service for multiple services over multiple authorization domains allows a user to remember just a single set of credentials for a variety of services from a variety of sources. Typically, when a user wishes to sign-on to a first service (e.g., launching an application for the first time, re-logging into an application, accessing a service through a web interface, accessing a service through digital media player, and/or another scenario in which the user is presented with an interface to authenticate with the service), the user is presented a user interface that displays a native sign-on user interface for the application and a single sign-on user interface (e.g., “connect with XYZ”).

A problem with single sign-on services is that the entity providing the single sign-on user service will share a user's private information with the individual service providers. Often, the sharing of private information is done without the user knowing about how this private information sharing works. For example, the user may unwittingly share, via the single sign-on service, how often the user is using one or more applications, the user's real name, the user's real email address, and/or other private information with the service provider that allows their service to be authorized through the single sign-on service.

### SUMMARY OF THE DESCRIPTION

A method and apparatus of a device that forwards an email from a first party, such as a developer, application provider, or service provider, to a second party, such as a user, is described. In an exemplary embodiment, the device receives an email, where the email includes a first email address associated with the first party, the first party email address is a “from” email address, a second email address associated with a second party, the second email address is a “to” email address; and the second email address is an anonymized email address. The device further extracts a local part of the second email address and the device determines a first party identifier from at least the local part of the first email address. In addition, the device determines a replacement address for the second email address using at least the first party identifier and replaces the second email address with the replacement address. The device further forwards the email using the replacement address.

A machine-readable medium having executable instructions to cause one or more processing units to perform a method to forward an email from a first party to a second party is described. In an exemplary embodiment, the machine-readable medium method receives an email, where the email includes a first email address associated with the first party, the first party email address is a “from” email address, a second email address associated with a second party, the second email address is a “to” email address; and the second email address is an anonymized email address. The machine-readable medium method further extracts a local part of the second email address and the machine-readable medium method determines a first party identifier from at least the local part of the first email address. In addition, the machine-readable medium method determines a replacement address for the second email address using at least the first party identifier and replaces the second email address with the replacement address. The machine-readable medium method further forwards the email using the replacement address.

In a further embodiment, the first party is a developer that provides a service and the second party is a user that has signed on for the service. In addition, the machine-readable medium method checks the first email address to determine it is an allowable email address. The machine-readable medium method performs the checking by retrieving a pattern of allowable email addresses using at least the first party identifier and using the pattern of allowable email addresses to check the first email address. The machine-readable medium method additionally checks the email by allowing the email when the first email address matches the allowable email pattern, and rejecting the email when the first email address does not match the allowable email pattern.

The machine-readable medium method further rejects the email when a number of emails from the first party to the second party exceed a threshold. In addition, the machine-readable medium method receives registration information from the first party, wherein the registration includes a pattern of allowable email addresses and generates the first party identifier using at least the registration information. Furthermore, the machine-readable medium method receives an indication of a second party sign on with a service provided by the first party, wherein the second party signs on includes second party sign on information. The machine-readable medium method generates a second party identifier using at least the second party sign on information and associates the second party identifier with the first party identifier.

In addition, the first party receives an indication that the second party is a real user, wherein the real user indication is part of the second party sign on information, and the real user indication is a single bit whether the second party is a real user or unknown. Furthermore, the real user indication is determined based on a set of signals collected by a device associated with the second party and the set of signals are at least one of mobility of the device, device usage, and a first party account history.

In a further embodiment, a machine-readable medium having executable instructions to cause one or more processing units to perform a method to forward an email from a first party to a second party is described. In one embodiment, the machine-readable medium method receives an email, wherein the email includes a first email address associated with the first party, the first party email address is a “from” email address, a second email address associated with a second party, the second email address is a “to” email address; and the first email address is an anonymized email address. Furthermore, the machine-readable medium method determines a first party identifier from first party email address and additionally determines a replacement email address based on at least the first party identifier, wherein the replacement email address is anonymized. In addition, the machine-readable medium method replaces the first email address with the replacement email address and forwards the email using the replacement email address.

In another embodiment, the machine-readable medium method determines the replacement email address by confirming the first party email address is associated with the first party identifier and constructing the replacement email address from at least the first party identifier. In addition, the machine-readable medium method confirms the replacement email address by performing a lookup using the first party identifier to obtain a first party known email address, comparing the first party email address and the first party known email address, and determining confirmation based on the comparison.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 is an illustration of one embodiment of a system that includes a private relay for sending and/or receiving anonymized emails between a user and a developer.

FIG. 2 is an illustration of one embodiment of a system that includes a private relay for sending and/or receiving anonymized emails between a user mail transfer agent and a developer mail transfer agent.

FIG. 3 is an illustration of an application sign on.

FIG. 4A is an illustration of one embodiment of a user interface for configuring the anonymous email relay.

FIG. 4B is an illustration of one embodiment of a user interface for signing onto an application.

FIG. 5 is a flow diagram of one embodiment of a process to register a developer for the anonymous email relay.

FIG. 6 is a flow diagram of one embodiment of a process to handle a user sign on for the anonymous email relay.

FIG. 7 is a flow diagram of one embodiment of a process to forward an email from a developer to a user using the anonymous email relay.

FIG. 8 is a flow diagram of one embodiment of a process to forward an email from a user to a developer using the anonymous email relay.

FIG. 9 is an illustration of one embodiment of a system for caching the application information related to the anonymous user email.

FIG. 10A is a flow diagram of one embodiment of a process to cache the application information related to the anonymous user email.

FIG. 10B is a flow diagram of one embodiment of a process 1050 to validate an authorization request.

FIG. 11 is an illustration of one embodiment of a system to return an indication of whether the user is an actual user.

FIG. 12 is a flow diagram of one embodiment of a process to return an indication of whether the user is an actual user.

FIG. 13 illustrates one example of a typical computer system, which may be used in conjunction with the embodiments described herein.

FIG. 14 shows an example of a data processing system, which may be used with one embodiment of the present invention.

### DETAILED DESCRIPTION

A method and apparatus of a device that forwards an email from a first party to a second party is described. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus of a device that forwards an email from a first party to a second party is described. In one embodiment, a single sign-on service is a service that allows a user to use a single set of credentials to sign-on to multiple services across one or more authorization domains. For example, a user could use a single username and password combination (or another set of user credentials) to sign-on for media streaming service from one company and a social media account from another company, even though these two companies are in different authorization domains. In this embodiment, having a single sign-on service for multiple services over multiple authorization domains allows a user to remember just a single set of credentials for a variety of services from a variety of sources. Typically, when a user wishes to sign-on first service (e.g., launching an application for the first time, re-logging into an application, accessing a service through a web interface, accessing a service through digital media player, and/or another scenario in which the user is presented with an interface to authenticate with the service), the user is presented a user interface that displays a native sign-on user interface for the application and a single sign-on user interface (e.g., “connect with XYZ”).

A problem with single sign-on services is that the entity providing the single sign-on user service will share a user's private information with the individual service providers. Often, the sharing of private information is done without the user knowing about how this private information sharing works. For example, the user may unwittingly share, via the single sign-on service, how often the user is using one or more applications, the user's real name, the user's real email address, and/or other private information with the service provider that allows their service to be authorized through the single sign-on service. In addition, data from other service associated with other service providers that are signed on with the single sign on service may be provided this service provider.

In one embodiment, a new single sign-on service allows the user to sign-on with different services across different authorization domains using a single set of credentials and without sharing the private information unless the user explicitly authorizes this private information sharing. In this embodiment, for the new single sign-on service, the user is associated with a user identifier that can be used to authenticate a user and authorize the user and/or the user's devices to use one or more services across multiple authorization domains. In addition, the user can control what information is shared with these service providers. In one embodiment, each of the user's devices is a trusted device. In a further embodiment, each device in a set of the user's devices has been authenticated with second factor authentication. For example and in one embodiment, a trusted device is a device that the authentication domain knows is a user device for a user and that can be used to verify a user's identity. In one embodiment, this single sign on service can work across a variety of device and operating systems associated with the user.

In one embodiment, an authorization domain is a collection of one or more services and/or authorization mechanism(s) that allow a user to be authorized for the one or more of the services provided by authorization domain using the authorization mechanism(s) of that authorization domain. In addition, one or more user devices associated with a user can be authorized for the one or more authorization services using these authorization mechanism(s). In one embodiment, each user is associated with a unique identifier (e.g., the user identifier) that can be used across the authorization domain. For example and in one embodiment, an authorization domain can be used by a user and/or the user's device(s) to purchase applications, purchase and/or stream media, store content in a cloud storage, access social media, and/or other types of services.

In one embodiment, the new single sign-on service provides a single sign-on for multiple services provided by a native application on the user's device or through a web browser across multiple authorization domains. An example of this single sign-on service is illustrated in U.S. Pat. No. 11,582,229, entitled “SYSTEMS AND METHODS OF APPLICATION SINGLE SIGN-ON”, issued on Feb. 14, 2023, which is incorporated herein by reference. This allows a user to sign-onto different applications and/or services with the user's identifier without exposing the user identifier (and/or other private information) to the developers or providers of the different applications and/or services.

In addition, the new single sign-on service provides for a proximity single sign-on on a first device, where a second user device allows a user to enter a set of credentials identifying the user so as to authorize a service on that first device. An example of this single sign-on service is illustrated in U.S. Pat. No. 12,299,107, entitled “SYSTEMS AND METHODS FOR PROXIMITY SINGLE SIGN ON”, issued on May 13, 2025, which is incorporated herein by reference.

Furthermore, the new single sign-on service can protect a user's real email address by providing an anonymous email relay. This anonymous email relay is used to hide a user's real email address between the user and one of the service providers (e.g., a developer of an application that the user signed on to using the new single sign-on service). The single sign-on service, in one embodiment, allows a user to remember only the user identifier across many different applications and the user can get email from a third party developer without exposing the user's identifier info through the email account set up for the user and that developer.

Moreover, the new single sign-on service provides a real user indicator to the service providers using a privacy preserving machine learning risk assessment system that allows that service provider to forgo using other mechanisms for indicating a real user is using their service (e.g., allowing the service provider to forgo using an extra user verification step such as a completely automated public Turing test to tell computers and humans apart (CAPTCHA) mechanism).

In addition, the new single sign-on service allows a user to use a user identifier associated with one authorization domain for signing on with applications and/or services of other authorization domains, where the user identifier and/or the user device are not part of the other authorization domains. In one embodiment, the user can sign-on to one or more applications that are part of authorization domains A₁, . . . , Aₙ using the user identifier that is part authorization domain B. This sign-on service enables the use of the applications on one or more of the user's devices, without revealing the user identifier or other private information to the developers or providers of those applications. In addition, the user identifier can be used for signing onto one or more applications that are part of the authorization domain B.

Periodically, a developer may want to email (or otherwise contact) a user (e.g., email about new updates, how to use features, new apps, news, marketing, etc.). If the SSO is not passing the user's email address to the developer, the developer cannot contact the user. With an anonymous email relay as described below, the developer can contact the user without the user revealing the user's email address. Instead, the developer sends an email to the user using anonymized email address that is relayed using a private email relay. In one embodiment, an anonymized email address is an address that is unknown except by a private relay mail transfer agent (MTA) that can map the anonymized address to the user's real email address. In this embodiment, the private relay MTA maps the user's anonymized email address to the user's real address. In addition, the private relay changes the developer's email address so that a reply email to the developer is properly routed through the private relay MTA.

In addition, a user's device maintains a cache of which applications installed on the device are associated with an anonymized email. Using this cache allows the developer-user relations to be long-lived that can persist over device reboots, device upgrade, and/or application upgrades. In one embodiment, the anonymized email for a developer user combination lives until one of the developer or the user expressly revokes the association.

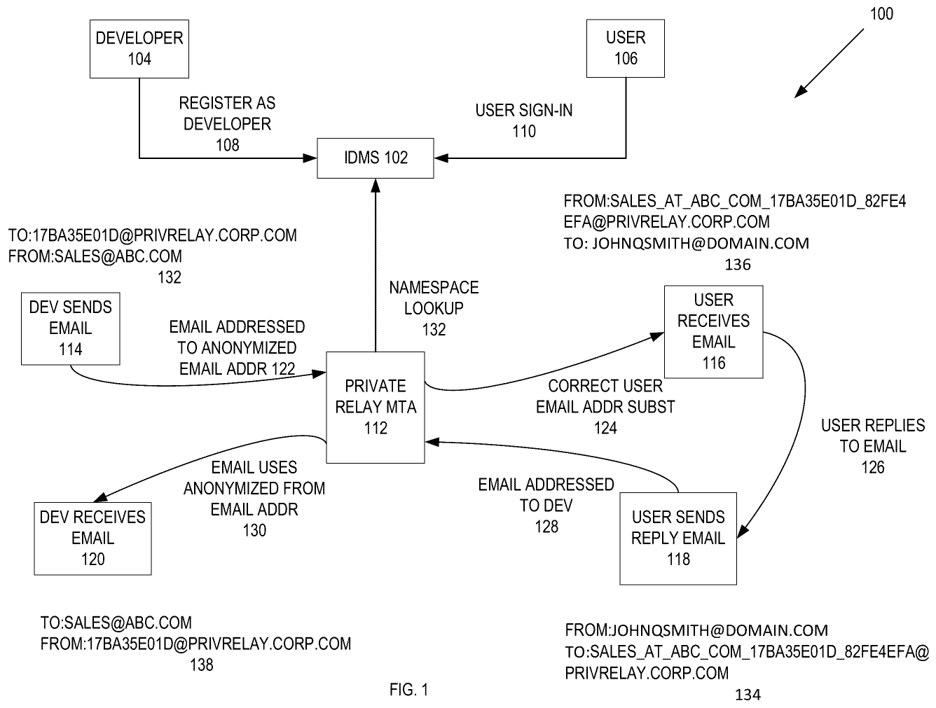

FIG. 1 is an illustration of one embodiment of a system 100 that includes a private relay 112 for sending and/or receiving anonymized emails between a user and a developer. In FIG. 1, the system 100 includes an identity management service 102 that is used to keep track of developers that are registered for applications that have users that opted in to single sign on to those applications. In one embodiment, a developer 104 registers with the identity management service 102 one or more applications. In one embodiment, a developer 104 is a person or business that creates, markets, and/or sells those one or more applications. Furthermore, an application is software that runs on a device that includes a processor for executing the instructions of that application. The application can run on any type of device that can execute an application (e.g., smartphone, laptop, personal computer, server, tablet, wearable, vehicle component, and/or any type of device that can process instructions of an application).

The “developer” may also be referred to as a “service provider” or an “application provider.” Any of these may be referred to herein as a “provider.” A service provider or application provider may or may not “develop” a product or service. A service provider or an application provider may be in the business of managing an application or service developed by a developer or some other party but may provide access to the service or application for users.

In one embodiment, when the developer registers with the identity management service 102, a developer identifier is generated by the identity management service 102. A developer 104 can have one developer identifier or multiple developer identifiers for different bundles of one or more applications (e.g., an entity with a large number of software engineers). In addition, for each developer registration or developer identifier, the developer 104 provides an email or email pattern that is used later for checks that the emails are from that developer. Furthermore, the developer information is stored in the identity management service 102.

The user 106, in one embodiment, can be any person that wants to use the application of the developer 104. In this embodiment, the user 106 signs in to the application via the identity management service 102. In one embodiment, the user 106 can use a global user identifier for an authorization domain that is associated with the identity management service 102 (e.g., the global user identifier can be a user's real email address). In one embodiment, the global user identifier is the primary user identifier used global for the authorization domain of the single sign on service. Because the identity management service 102 can hide the private information of the user 106, the identity management service does not reveal this global user identifier to the developer 104. In a further embodiment, the identity management service 102 creates an anonymous user identifier that is used as an identifier for the combination of the user 106, the developer 104, and/or a set of applications. In one embodiment, of the user's real email addresses can be associated with multiple anonymous user identifiers and multiple developer identifiers. In one embodiment, the anonymous user identifier is a machine generated unique user identifier.

Because the identity management service 102 can hide the user's personal information, when the user signs in to the application 110, the identity management service 102 prompts the user 106 for how the user 106 would like to have their private information shared with the developer. For example and in one embodiment, the identity management service 102 asked the user, by the user's device, if the user 106 wishes to share the user's real name and the user's real email address. If the user 106 indicates no for other piece of information, the identity management service 102 does not reveal that type of information. In one embodiment, if the user 106 does not want to share the user's real email address, the identity management service 102 can provide to the developer 104 an anonymized email address that the developer 104 can use to send emails to the user 106. In this embodiment, the anonymized email address will direct an email to a private relay mail transfer agent (MTA) 112 that can be used to relay an email from the developer 104 to the user 106 (and vice versa, if the user replies to that email from the developer). This anonymized email address is provided to the developer 104 after the user 106 signs in with the application via the identity management service 102. In addition, the identity management service 102 can provide a confidence assessment as to whether a user is real user to the developer 104, where the real indication is an indication whether the user that signed on with the application is a real user or is unknown to be a real user. In one embodiment, the real user indication is computed using a privacy preserving machine learning model that determines if a device that is tied to the user 106 is being used as a normal person would use the device. The real user indication is described further below.

With the user's anonymized email address, the developer 104 can send an email to the user 106 using the anonymized email address. In one embodiment, the developer 104 initiates the email as the user 106 does not have a privacy preserving email mechanism to send an email to the developer 104 using the private relay MTA 112. In another embodiment, a user can initiate the email sequence by the application. In one embodiment, to contact the user, the developer 104 creates an email that uses the anonymous email address as the “to” email address and uses the developers email address as the “from” address. In this embodiment, the developer's “from” address should match the allowed pattern email address that the developer 104 used to register with the identity management service 102 or this email will be bounced by the private relay MTA 112. With the email completed, the developer 104 sends the email 122 that is addressed to the anonymized email address 122. For example and in one embodiment, the developer 104 may wish to send an email that's addressed to “johnqsmith@domain.com.” In this example, the developer 104 does not have the user's real email address, so uses the anonymized email address instead, which in this case is “17BA35E01D@privaterelay.corp.com.” The “from” address for this email would be “sales@abc.com.”

The private relay MTA 112, in one embodiment, receives the email from the developer 104 and retrieves the local part of the user email address. For example and in one embodiment, if the user email address is “17BA35E01D@privaterelay.corp.com,” the local part of the user email address is “17BA35E01D.” In one embodiment, the local part of the user email address is the anonymous user identifier as described above. The private relay MTA 112 can use this local part of the user email address to perform a lookup of the user information. Because the anonymous user identifier is unique for particular combination of a user real email address and a developer identifier, the anonymous user identifier is associated with the developer identifier. This allows the private relay MTA 112 to retrieve the developer identifier. With the developer identifier, the private relay MTA 112 can find the allowed email pattern that is associated with this developer identifier. The private relay MTA 112 can further check the received email to determine if the “from” email address matches the allowed email pattern associated with the developer identifier. If the “from” email address does not match the allowed email pattern, the private relay MTA 112 will bounce this email. However, if the “from” email address does match the allowed email pattern, the private relay MTA 112 can perform further checks on the received email. For example and in one embodiment, the private relay MTA 112 limits the number of emails sent by the developer 104 to the particular user 106. Thus, the private relay MTA 112 checks if this email is within the allowed limit for email sent by the developer 104 to the particular user 106. In addition, the private relay MTA 112 can perform further checks on the email, such as a spam checker, DNS checks, policy checks, and/or check that the email was signed.

In one embodiment, the private relay MTA 112 replaces the “to” and “from” email addresses before sending the email. In this embodiment, the private relay MTA 112 replaces the “to” email address with the user's real email address (e.g., johnqsmith@domain.com). In addition, the private relay MTA 112 replaces the developer's “from” email address with a new email address that allows the receiving user to reply to this email such that the reply will be forwarded through the private relay MTA 112. For example and in one embodiment, the developer's “from” email address is converted from the developer's email address to an email address based on the developer's email address, the anonymous user ID, a tamper hash, and a private relay domain name. For example and in one embodiment, if the developer's email addresses “sales@abc.com” with the anonymous user identifier being 17BA35E01D, the new “from” email address can be SALES_AT_ABC_COM_17BA35E01D_82FE4EFA@PRIVRELAY.CORP.COM. With the new email, the private relay MTA 112 since the new email to the user, where the user receives the email 116.

The user may reply to this email 126. If the user sends a reply email 118, the “from” email address will be johnqsmith@domain.com and the “to” email address will be the manipulated developer email address, which in this case is the email address SALES_AT_ABC_COM_17BA35E01D_82FE4EFA@PRIVRELAY.CORP.COM 134. The user sends this email that is addressed to the developer 128. The private relay MTA 112 receives this email and converts both the “from” and “to” email addresses, so that the email preserves the privacy of the user's real email address and allows the email to be forwarded onto the developer. In addition, so as to further preserve the privacy of the user's information, the private relay MTA 112 removes the user's real email address or other private information from the headers in the email. In one embodiment, the private relay MTA 112 does not change the contents of the body, even if the user reveals some private information. For example and in one embodiment, the private relay MTA 112 uses the anonymized user email address 130 for the “to” email address and the developers email address as the “from” email address. In addition, the private relay MTA 112 can perform additional checks on the email as described above. In this example, the “from” email address will be sales@abc.com and the “to” email address is 7BA35E01@PRIVRELAY.CORP.COM. The private relay MTA 112 sends the email to the developer where the developer receives the email 120.

In one embodiment, the private email relay allows the developer to email the user without the user's real email address being revealed to the developer. In this embodiment, in addition to the preservation of the privacy of the user's real email address, other private information of the user can be hidden from the developer (e.g., user's real name, when or how often the user uses the application, what times the user uses the application, and/or other information that is private to the user or relates to the user's pattern of use of the device or the application).

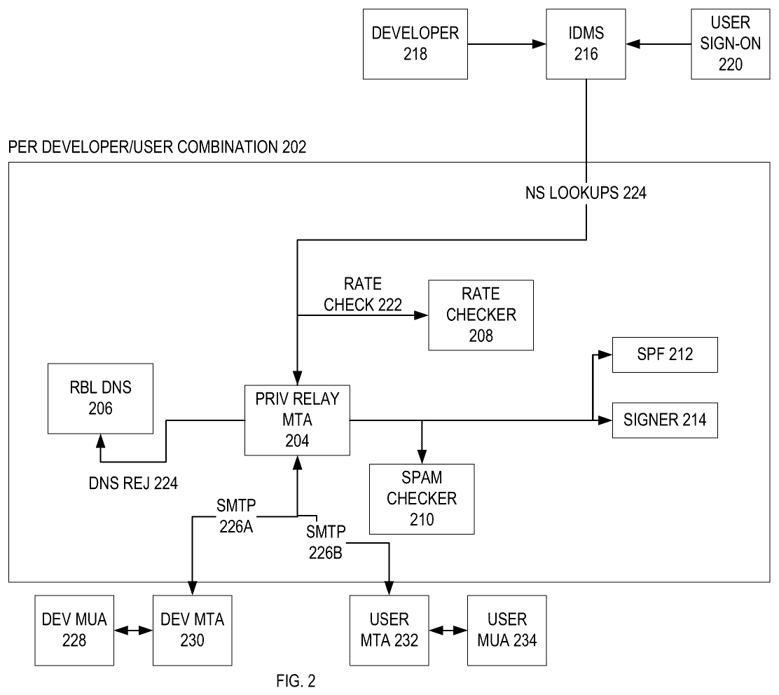

FIG. 2 is an illustration of one embodiment of a system 200 that includes a private relay 204 for sending and/or receiving anonymized emails between a user mail transfer agent (MTA) 232 and a developer MTA 230. In FIG. 2, the system 200 operates on a unique combination of the developer identifier and the anonymous user identifier 202. As in FIG. 1, the developer 218 registers with the identity management service 216, where the identity management service 216 generates a developer identifier. In addition, the user signs on 220 to the application with the identity management service 216, where this generates the anonymous user identifier that is provided to the developer 218. As described in FIG. 1 above, if the developer 218 wishes to send an email to the user, the developer uses the anonymized email address of the user and the developer's normal “from” email address.

In one embodiment, when a developer sends an email, the developer mail user agent (MUA) 228 forwards email to the developer MTA 230. The developer MTA 230, in turn, sends the email to the private relay MTA 204 using the simple mail transfer protocol (SMTP) 226A. The private relay MTA 204 receives this email and updates the email addresses as described in FIG. 1 above. The private relay MTA 204 further performs a namespace lookup with the identity management service 216 (or with an identity management service cache (not illustrated)) so as to determine the user's real address. In addition, the private relay MTA 204 performs a number of checks to determine if the received email is valid. For example and in one embodiment, the private relay MTA 204 performs a rate check 222 using a rate checker 208 to determine if the developer is sending too many emails to the user within a certain time period (e.g., say no more than 5 emails in a 24 hours period). In addition, the private relay MTA 204 can perform a spam checker 210 to determine if the email is spam. Furthermore, the private relay MTA 204 can perform a real-time blackhole list (RBL) domain name system (DNS) 206 lookup check to make sure the email was not sent from a domain that is marked as having sent spam email 224. The private relay MTA 204 can further use a sender policy framework 212 that is designed to detect fraudulent sender email addresses in the email. The private relay MTA 204 can additionally check to make sure that the email is signed 214. If the email is not valid, and in one embodiment, the private relay MTA 204 rejects the email. On the other hand, if the email is valid, the private relay MTA 204 forwards the email with the updated email addresses using SMTP 226B to the user MTA 232, where the user MTA 232 delivers the email to the user and MUA 234.

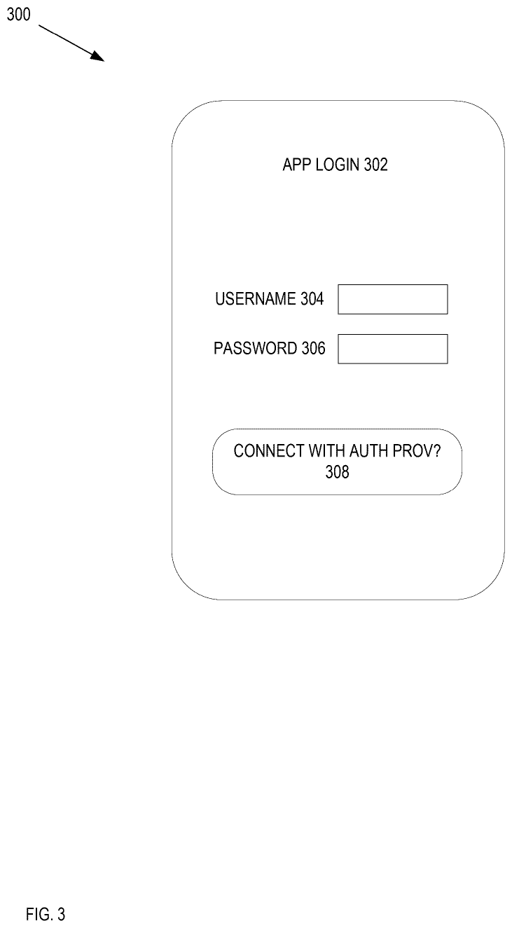

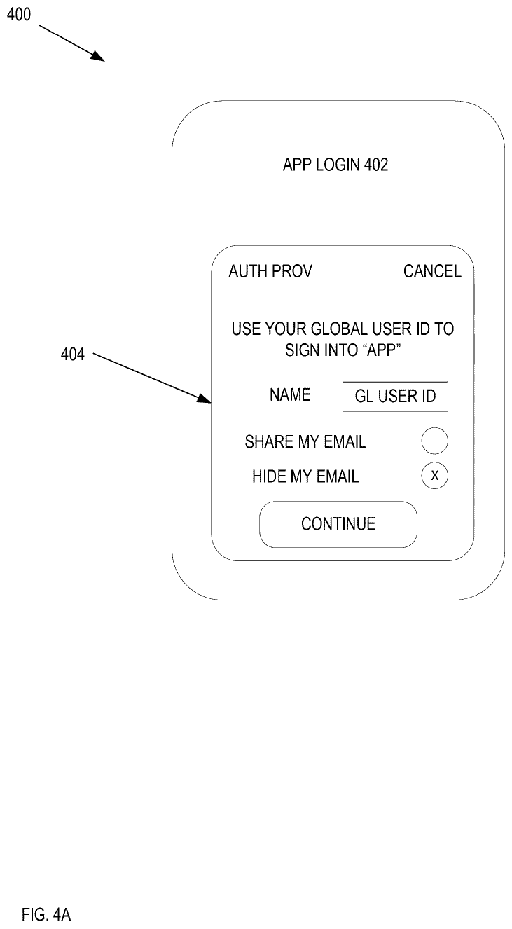

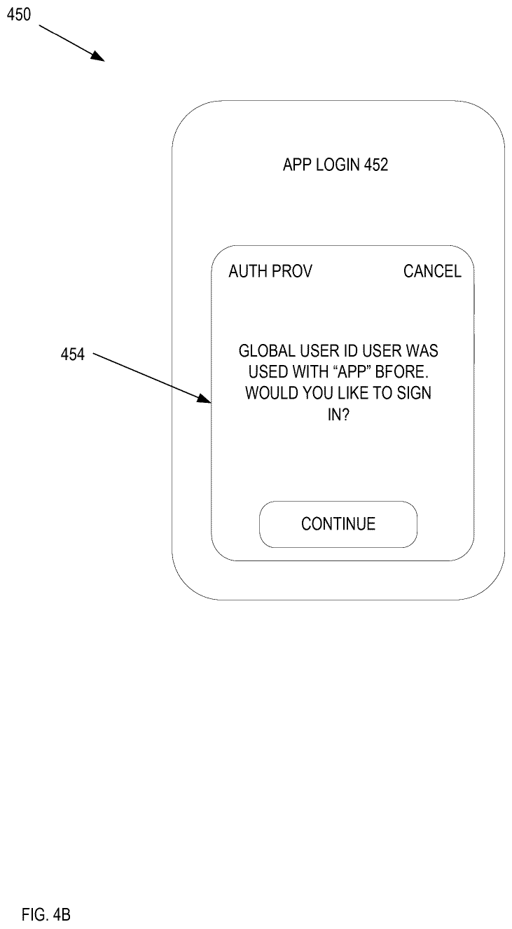

FIG. 3 is a user interface 300 of an application sign on. In one embodiment, the user interface 300 includes a title 302, username 304, password 306, and a user interface component for connecting to the authorization provider 308. In one embodiment, the username 304 and password 306 are text boxes for entering user credentials (e.g., username and passwords) that is used for a native sign on with the application that does not utilize the private relay or the anonymous email address. In contrast, the user interface component for connecting to the authorization provider 308 is used by the user to setup anonymous email address for the user. The term “authorization provider” may refer to an identity management service. Alternatively, an “authorization provider” may be an intermediate function that provides access to the identity management service. This is further described in FIG. 4 below.

FIG. 4A is an illustration of one embodiment of a user interface 400 for configuring the anonymous email relay. In FIG. 4, the user interface 400 illustrates an overlay user interface sheet 404 that overlays the user interface 300 as illustrated in FIG. 3. This user interface 400 illustrates that an authorization provider setting up the anonymous user email using the global user identifier for the user if the user selects the option “HIDE MY EMAIL.” Alternatively, the user is presented with the option of sharing their email if the user selects the option “SHARE MY EMAIL.” In addition, the user interface 400 displays the global user identifier.

FIG. 4B is an illustration of one embodiment of a user interface 450 for signing onto an application. In FIG. 4A, the user interface 450 illustrates an overlay user interface sheet 454 that overlays the user interface 300 as illustrated in FIG. 3. This user interface 400 illustrates that a user has signed in previously to the application with the global user identifier. In addition, the overlay user interface sheet 454 displays the global user identifier, prompting the user to continue. If the user taps continue, the sign-on proceeds using the cache authorization code and token.

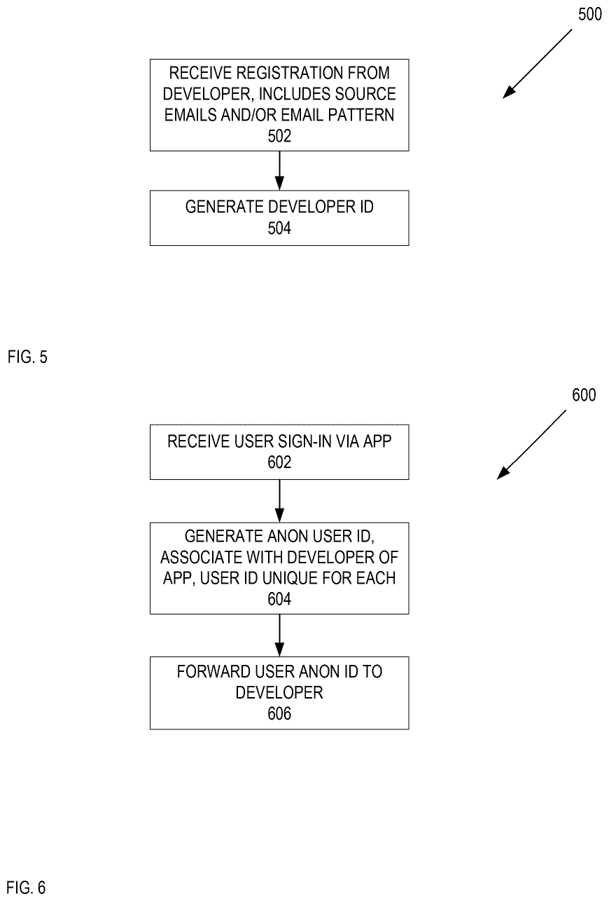

FIG. 5 is a flow diagram of one embodiment of a process to register a developer for the anonymous email relay. In FIG. 5, process 500 begins by receiving a registration from the developer that includes information regarding developer source email addresses and/or allowed email patterns at block 502. As described above in FIG. 1, the developer source email addresses and/or the allowed email patterns are used to check the “from” email addresses that are received from the developer to make sure these are valid emails. At block 504, process 500 generates the developer identifier as described in FIG. 1 above.

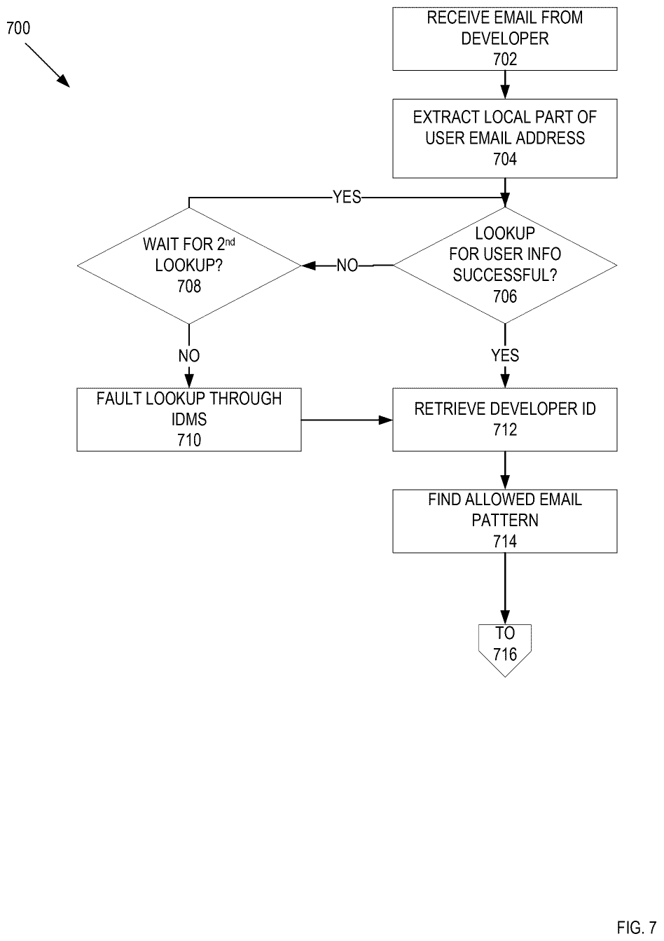

FIG. 6 is a flow diagram of one embodiment of a process to handle a user sign on for the anonymous email relay. In FIG. 6, process 600 begins by receiving an indication of user sign in via the application at block 602. In one embodiment, the user sign in can include the user's global user identifier or another identifier tied to global user identifier (e.g., a secondary email address for the user). Alternatively, the user can permit access to a password management system to allow the use of the user's password for the global user identifier without the user having to enter tis password. At block 604, process 600 generates the anonymous user identifier and associates this identifier with the developer identifier of the application. In one embodiment, the anonymous user identifier is a machine generated identifier. In one embodiment, the anonymous user identifier is associated with a developer identifier and is unique within the authorization domain of the identity management service. In a further embodiment, the anonymous user identifier and the developer identifier are stored in a table along with other information for this relationship (e.g., anonymized user email address, the user's real email address, what private information to share, and other information used to maintain this association). Process 600 additionally forwards the user anonymous identifier, the anonymized user email address, and possible non-private user information to the developer at block 606.

In one embodiment, the developer can use the anonymous user identifier to track the actions of the user within the application of the developer that the user has performed a sign-on. In this embodiment, when the user signs on with the application, the developer can track the actions the user performed with the application (e.g., ordered merchandise, streamed media, browsing with the application, and/or other types of actions with the developer's application) through functions in the application and the identity management service sending sign on information to the developer. Thus, the developer can use the anonymized user email address and the tracked information about the user to send targeted email to the user. In one embodiment, however, because the application authorization cache is stored on the device and not on a remote server, the developer cannot retrieve information on how the user uses applications that are not associated with the developer. In this embodiment, the user's application usage that is outside of the developer is shielded from the developer.

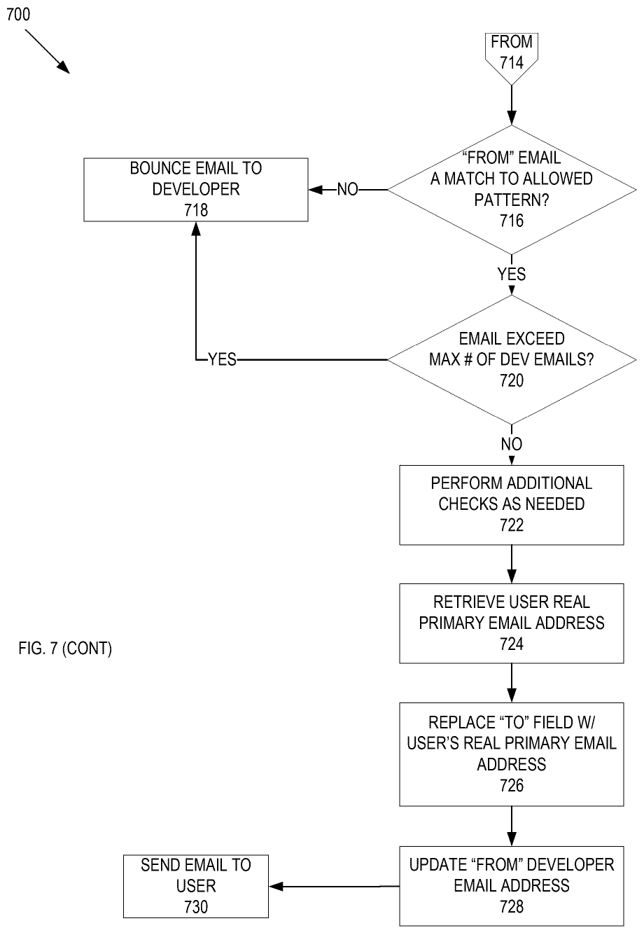

FIG. 7 is a flow diagram of one embodiment of a process 700 to forward an email from a developer to a user using the anonymous email relay. In FIG. 7, process 700 begins by receiving an email from a developer at block 702. In one embodiment, the “from” email address is the developer email address and the “to” email address is the anonymized user email address as described in FIG. 1 above. At block 704, process 700 extracts the local part of the anonymized email address. In one embodiment, the local part of the anonymized email address corresponds to the anonymous user identifier that was assigned by the identity management service. Process 700 uses this local part of the anonymized email address to perform a lookup for the user information. At block 706, process 700 determines if this lookup was successful. If the lookup is successful, execution proceeds to block 712 below. If the lookup is not successful, process 700 can wait for a time period (e.g., 60-500 seconds) at block 708 and try the lookup again at block 706. If process 700 is not waiting for the second lookup, process 700 can fault the lookup through the identity management service at block 710. Execution proceeds to block 712 below.

At block 712, process 700 retrieves the developer identifier. In one embodiment, process 700 retrieves the developer identifier from the user information lookup, where the user information is associated with the developer identifier. Process 700 finds the allowed email pattern of the developer at block 714. At block 716, process 700 determines if the “from” email address is a match to the allowed email pattern of the developer. If there is not a match, process 700 bounces the email to the developer at block 718. If there is a match, process 700 proceeds to block 720, where process 700 checks to see if the received email exceeds the maximum number of emails that can be sent from the developer to the user. If the received email is greater than the maximum number of emails allowed, process 700 bounces the email to the developer at block 718. If the received email does not exceed the maximum number of allowed emails, process 700 performs additional checks as needed. In one embodiment, process 700 can email such as a spam checker, a DNS check, check the email is signed, and/or a policy check as described in FIG. 2 above. If these checks pass, process 700 retrieves the user's real primary email address at block 724. In one embodiment, the user's real primary email address is stored in the same table as the anonymous user identifier and other information used by the private relay MTA. At block 726, process 700 replaces the “to” email address with the user's real primary email address. Process 700 further updates the developer “from” email address at block 728. In one embodiment, process 700 updates the developer email address as described in FIG. 1 above. At block 730, process 700 sends the email to the user.

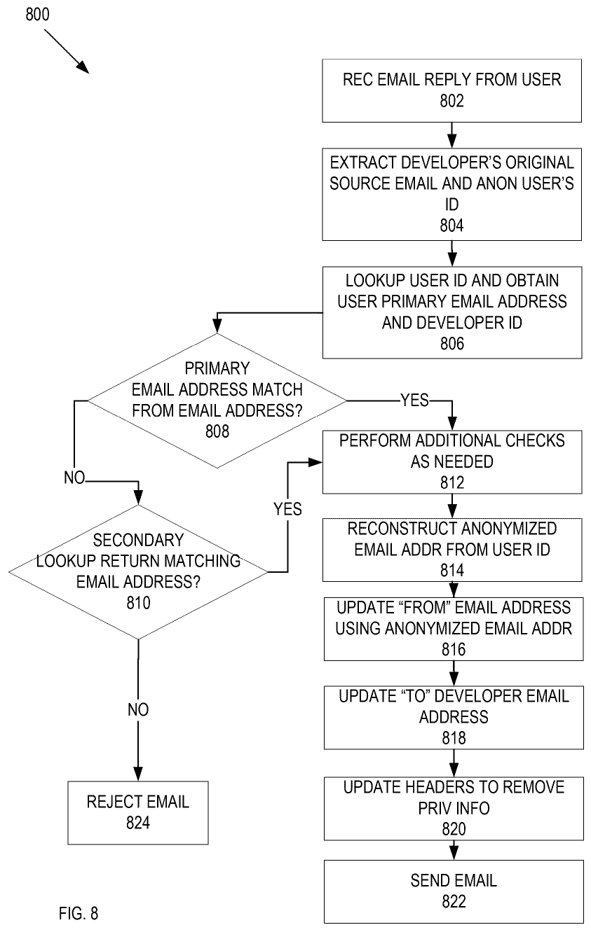

FIG. 8 is a flow diagram of one embodiment of a process to forward an email from a user to a developer using the anonymous email relay. In FIG. 8, process 800 begins by receiving an email reply from the user at block 802. In one embodiment, the reply email includes the user's primary real address as the “from” email address and the manipulated developer email address as the “to” email address. At block 804, process 800 extracts the developer's original source email address and the anonymous user identifier. In one embodiment, the manipulated developer email address includes a transformed developer email address, the anonymous user identifier, a tamper hash, and the domain name for the private relay. In this embodiment, process 700 un-transforms the developer email address and extracts the anonymous user identifier from the “from” email address. With the anonymous user identifier, process 800 looks up the user identifier and obtains the user's primary email address and the developer identifier at block 806. At block 808, process 800 determines if the primary email address matches the from email address. If not, process 800 determines if a secondary lookup returns the matching email address at block 810. If the secondary lookup does return the matching email address, execution proceeds to block 812 below. If the secondary lookup does not return the matching email address, process 800 rejects the email at block 824. If, at block 808, the primary email address does match the “from” email address, execution proceeds to block 812 below.

At block 812, process 800 performs additional checks as needed. In one embodiment, process 800 can perform email checks such as a spam checker, a DNS check, a check that the email is signed, and/or a policy check as described in FIG. 2 above. At block 814, process 800 reconstructs the anonymized email address from the anonymous user identifier. Process 800 updates the “from” email address using the anonymized email address at block 816. At block 818, process 800 updates the “to” developer email address. In one embodiment, process 800 updates the “to” developer email address as described in FIG. 1 above. Process 800 further updates the headers to remove possible user private information. In one embodiment, the headers may include private information such as the user's real primary email address. In this embodiment, process 800 examines the headers of the email and removes any user private information, including the user's primary real address. At block 822, process 800 sends the email to the developer.

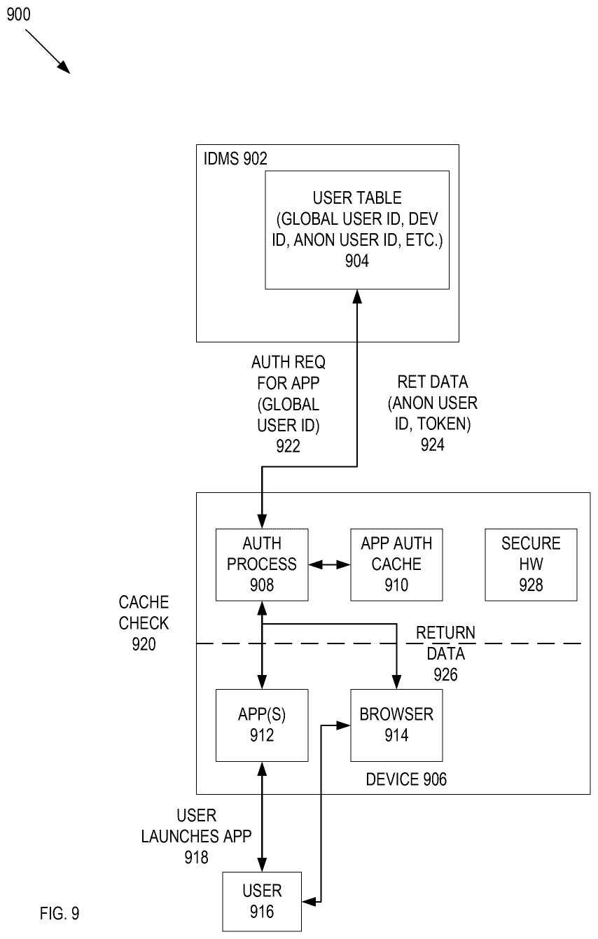

FIG. 9 is an illustration of one embodiment of a system 900 for caching the application information related to the anonymous user email. In FIG. 9, the device 906 is coupled to an identity management service 902. In one embodiment, the identity management service 902 is the identity management service 102 that is described in FIG. 1 above. In addition, device 906 is trusted by the identity management service 902 because of an established trust relationship between the device 906 and the identity management service 902 that was established by two-factor authentication. In one embodiment, the two-factor authentication uses the user user's global user identifier. In this embodiment, the device 906 can be any type of device that can execute an application (e.g., smart phone, laptop, personal computer, server, tablet, wearable, vehicle component, and/or any type of device that can process instructions of an application). The device 906 further includes one or more applications 912, a browser 914, an authorization process 908, and an application authorization cache 910. In one embodiment, the one or more applications 912 are each an embodiment of software that runs on the device 906 and can perform a variety of functions. Furthermore, in this embodiment, the browser 914 can be a web browser that can make and receive requests for data over a network coupled to device 906. In this embodiment, the authorization process 908 is a process that is not a process or a child process for either the application(s) 912 or the browser 914.

The device 906 additionally includes an authorization process 908 that communicates with the identity management service 902 for the one or more applications 912 or the browser 914. In particular, the authorization process 908 determines if the user 916 is authorized for the one or more applications 912 or the browser 914 using the application authorization cache 910 and/or the identity management service 902. In one embodiment, the user launches (918) an application 912 and prompts the user 916 if the user wishes to use the single sign on service. The authorization process 908 detects the launch of the application 912 and checks (920) the application authorization cache 910 to determine if the user 916 had previously signed on with the application 912 via the identity management service 902. If the authorization is still valid, the application authorization cache is refreshed with the global user identifier. If the application 912 is in the application authorization cache 910, the application 912 continues to launch, where the application 912 is configured for use with the private relay and the anonymous user email address. If the application 912 is not in the application authorization cache 910, the authorization process 908 sends an authorization request (922) for the application 912. In one embodiment, the authorization request (922) includes data that is used for the request, such as the global user identifier, developer identifier for the application 912, one or more tokens generated on the device 906, and/or other information used for the authorization request. The identity management service 902 includes a user table that associates the global user identifier, developer identifier, anonymous user identifier, and/or other information used by the identity management service 902 for that combination of user and developer. In this embodiment, the developer identifier for an application is generated when a developer associated with one of the applications 912 registers that application 912 with the identity management service 902. Furthermore, the anonymous user identifier is generated when the user signs-on for an application, where the anonymous user identifier is tied to the global user identifier and the developer identifier.

In response to receiving the authorization request, the identity management service 902 returns the local data (e.g., anonymous user identifier, authorization code, identity token, application token, and/or other information used by the authorization process on the device) (924) to the authorization process 908 of the device 906. In one embodiment, some or all of the local data can be stored in the application authorization cache 910. The authorization process 908, in turn, returns this data to the application 912, where the application 912 verifies the data so that user 916 is authorized to use the application 912. In one embodiment, the identity management service 902 refreshes the application authorization cache 910 for each time period (e.g., every 24 hours), on demand from the application, request from a user, pushed out based on user activity on other devices (e.g., a user signs on or off on a different device), a dynamic schedule, and/or another type of schedule. In a further embodiment, if a user explicitly signs out of the application 912 on one device (e.g., a user sign out, developer de-registration, or a revocation of use of the single sign on service by the user or developer), the identity management service 902 detects this sign out and pushes out the sign out to other devices of the user. For example and in one embodiment, if the user 916 signs out of an application 912 on a smartphone, the identity management service 902 pushes out a sign out for this application 912 on the other user 916 devices (e.g., the user's tablet or laptop).

As described above, in FIG. 9, the device 906 sends an authorization request for an application to the identity management service 902 if the authorization information for the application 912 is not stored in application authorization cache 910. In one embodiment, by using the application authorization cache 910, the device 906 can shield the user's private information from the developer, by use of a local cache (e.g., the application authorization cache 910) as the identity management server does not track user sign-ons to the application 912. In one embodiment, the device 906 further includes secure hardware 928. In this embodiment, the local authentication of the user 916 for the device 906 is performed by comparison of biometric data (or other user credentials) in the secure hardware 928 (e.g. via pincode, biometric credentials, and/or other types of authentication data).

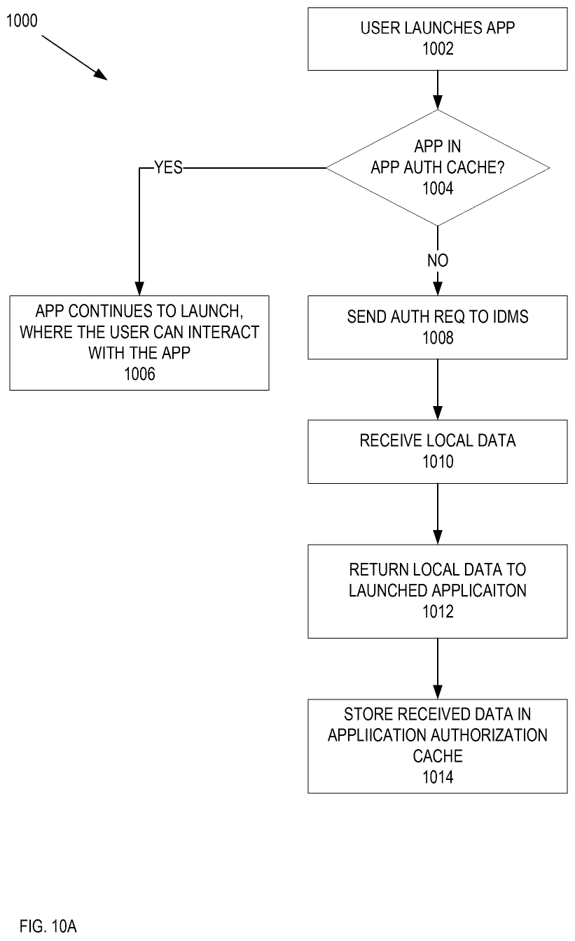

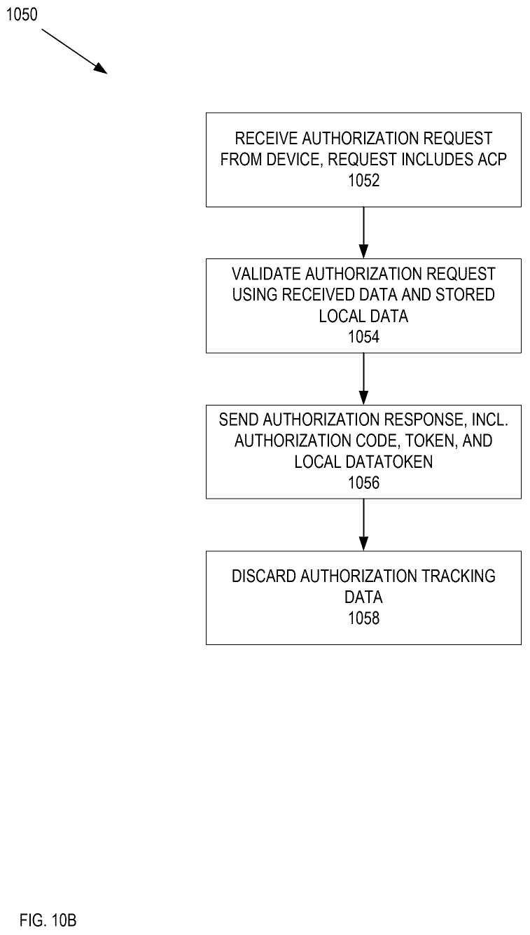

FIG. 10A is a flow diagram of one embodiment of a process 1000 to cache the application information related to the anonymous user identifier. In FIG. 10, process 1000 begins by detecting that a user has launched an application at block 1002. In one embodiment, the application launch is detected by an HTTP request that is intercepted as described in FIG. 5 above or the application invokes the authorization process as described in FIG. 9 above. At block 1004, process 1000 determines if the launched application information is in the application authorization cache. If the launched application is in the application authorization cache, execution proceeds to block 1006, where the application continues to launch and the user can interact with the application. In one embodiment, the launched application is configured to use the private relay and the anonymous user email address.

If, at block 1006, the application is not in the application authorization cache, process 1000 sends an authorization request to the identity management s at block 1008. In one embodiment, the authorization request includes information used by the identity management service to complete this request (e.g., global user identifier, developer identifier corresponding to this application, and/or any other type of information used by the identity management service to complete this request). At block 1010, process 1000 receives the local data that is sent by the identity management service in response to receiving the authorization request. In one embodiment, the local data includes the anonymous user identifier, an authorization code and token, and/or other information used by the authorization process on the device. Process 1000 returns the local data to the application at block 1012, where the application is configured to use the private relay and the anonymous user email address. In addition, the application is launched and the user can use the application. At block 1014, process 1000 stores the received data in the application authorization cache.

FIG. 10B is a flow diagram of one embodiment of a process 1050 to validate an authorization request. In one embodiment, an identity management service performs process 1050, such as the identity management service 902 as described in FIG. 9 above. In FIG. 10B, process 1050 begins by receiving an authorization request for an application at block 1052. In one embodiment, the authorization request is the authorization application request that includes the access continuation parameter as described in FIG. 9 above. At block 1054, process 1054 validates the authorization request using the access continuation parameter in received authorization request (and, potentially, some or all of the other data in the authorization request, such as the local data associated with this request (e.g., global user identifier, developer identifier corresponding to this application, and/or any other type of information used by the identity management service to complete this request)). In addition, process 1054 can use the local data stored with the identity management service to validate the request. Process 1050 sends the authorization response to the request device. In one embodiment, the authorization response includes the authorization code and token for the application as well as the local data for this device and application (e.g., anonymous user identifier, authorization code, identity token, application token, and/or other information used by the authorization process on the device) at block 1056. In addition, process 1050 can sends the anonymous sign on information to the developer as described in FIG. 6 above. At block 1058, process 1050 discards any tracking data used for this authorization request. In one embodiment, this data is discarded so as to preserve the privacy of the user and the user's sign on of the application.

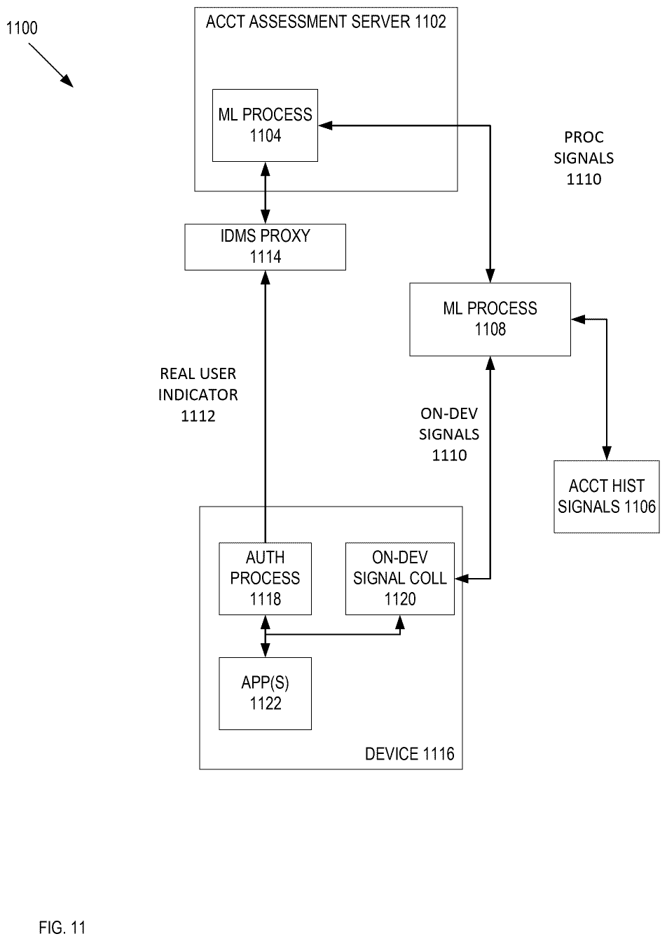

FIG. 11 is an illustration of one embodiment of a system 1100 to return a confidence assessment of whether the user is a malicious actor. In FIG. 11, the device 1116 is coupled to an identity management service proxy 1114, where the identity management service proxy 1114 is coupled to an account assessment server 1102. In one embodiment, the machine learning device 1102 includes a machine learning process 1104 that uses on device signals and account history signals to determine if the user associated with the device 1116 is a real user or unknown. In this embodiment, the machine learning process 1104 receives the account history signals from the account history signals process 1106. In one embodiment, the account history signals can include pattern of sign on times, an indication of a liveness check on an extended used of a device, use of different services, account history signals, and/or other signals. In a further embodiment, the machine learning process 1104 receives processed signals 1110 from the machine learning process 1108, which is, in one embodiment, a process that applies machine learning model to on device signals 1110. These on-device signals 1110 are received from the on device signal collection process 1120 that executes on the device 1116. In a further embodiment, at least some of the on-device are signals obscured and verified (e.g., the user “birthdate”) prior to sending these signals to the machine learning process 1108. Verifying and obscuring helps preserve the privacy of the user for determining this user indicator. In one embodiment, the on-device signal and account history signals are collected and processed into a real user indication by using a machine learning model as described in U.S. Pat. No. 11,588,804, entitled “Providing Verified Claims of User Identity,” issued on Feb. 21, 2023, which is incorporated by reference. In one embodiment, the identity management service 1112 receives the real user indicator, where the real user indicator is a single bit that either indicates the user associated with the device 1116 is a real user or is unknown.

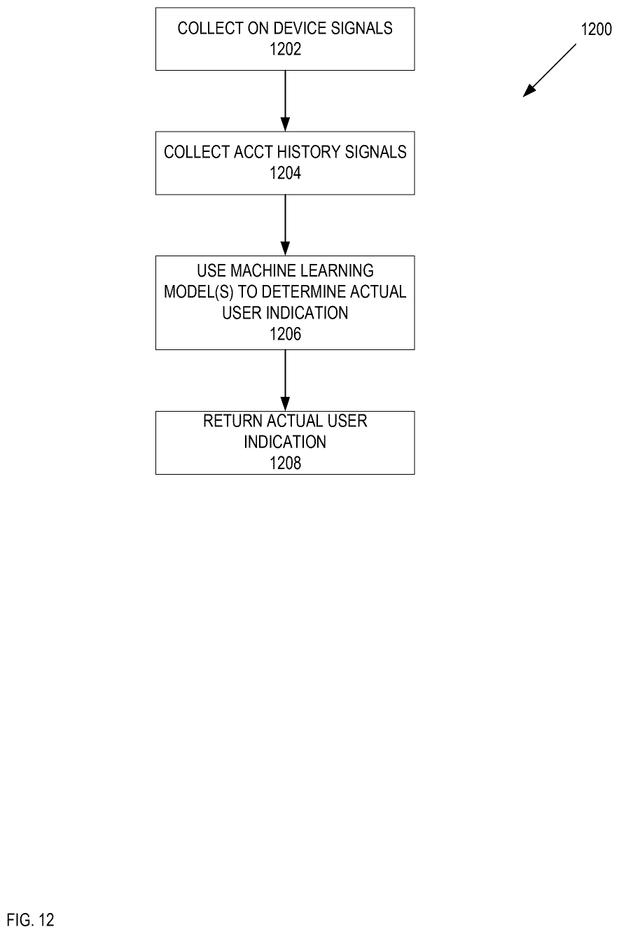

FIG. 12 is a flow diagram of one embodiment of a process to return an indication of whether the user is an actual user. In FIG. 12, process 1200 begins by collecting the on-device signals at block 1202. In one embodiment, process 1200 collects the on-device signals from signals as described in FIG. 11 above. At block 1204, process 1200 collects the account history signals for the user associated with the user. In one embodiment, process 1200 collects sign on times, use of different services, account history signals, and/or other signals. Process 1200 uses one or more machine learning models to determine the actual real user indication at block 1206. In one embodiment, process 1200 uses the machine learning models to determine a real user indication as described in U.S. Pat. No. 11,588,804, entitled “Providing Verified Claims of User Identity,” issued on Feb. 21, 2023. At block 1208, process 1200 returns the real user indication at block 1208. In one embodiment, process 1200 returns the real user indication to the identify management system as described in FIG. 11 above.

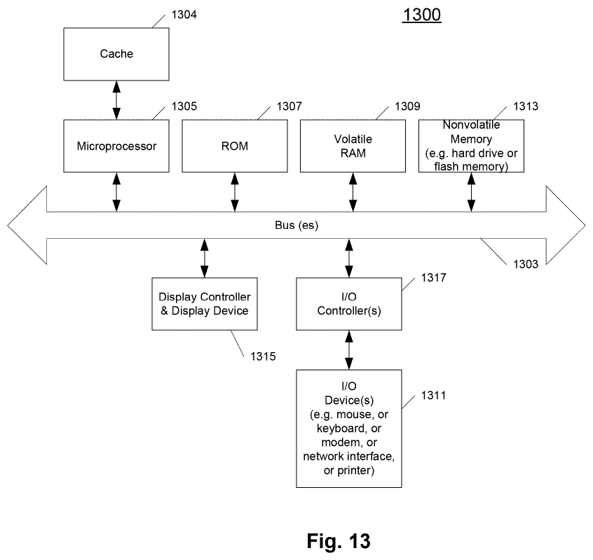

FIG. 13 shows one example of a data processing system 1300, which may be used with one embodiment of the present invention. For example, the system 1300 may be implemented as a system that includes a private relay MTA 112 as shown in FIG. 1 above or a device 906 as shown in FIG. 9 above. Note that while FIG. 13 illustrates various components of a computer system, it is not intended to represent any particular architecture or manner of interconnecting the components as such details are not germane to the present invention. It will also be appreciated that network computers and other data processing systems or other consumer electronic devices, which have fewer components or perhaps more components, may also be used with the present invention.

As shown in FIG. 13, the computer system 1300, which is a form of a data processing system, includes a bus 1303 which is coupled to a microprocessor(s) 1305 and a ROM (Read Only Memory) 1307 and volatile RAM 1309 and a non-volatile memory 1311. The microprocessor 1305 may include one or more CPU(s), GPU(s), a specialized processor, and/or a combination thereof. The microprocessor 1305 may retrieve the instructions from the memories 1307, 1309, 1311 and execute the instructions to perform operations described above. The bus 1303 interconnects these various components together and also interconnects these components 1305, 1307, 1309, and 1311 to a display controller and display device 13113 and to peripheral devices such as input/output (I/O) devices which may be mice, keyboards, modems, network interfaces, printers and other devices which are well known in the art. Typically, the input/output devices 1315 are coupled to the system through input/output controllers 1313. The volatile RAM (Random Access Memory) 13013 is typically implemented as dynamic RAM (DRAM), which requires power continually in order to refresh or maintain the data in the memory.

The mass storage 1311 is typically a magnetic hard drive or a magnetic optical drive or an optical drive or a DVD RAM or a flash memory or other types of memory systems, which maintain data (e.g. large amounts of data) even after power is removed from the system. Typically, the mass storage 1311 will also be a random access memory although this is not required. While FIG. 13 shows that the mass storage 1311 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 1303 may include one or more buses connected to each other through various bridges, controllers and/or adapters as is well known in the art.

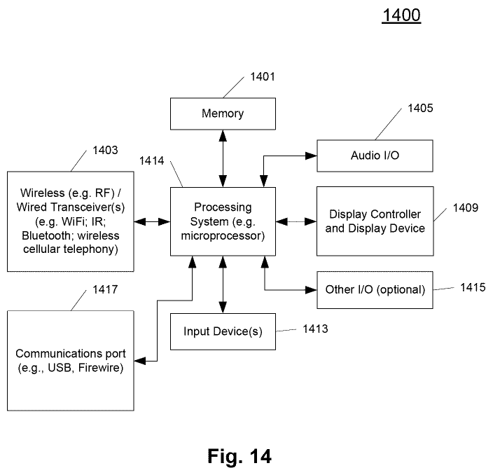

FIG. 14 shows an example of another data processing system 1400 which may be used with one embodiment of the present invention. For example, system 1400 may be implemented as a build system 146 as shown in FIG. 1 above. The data processing system 1400 shown in FIG. 14 includes a processing system 1411, which may be one or more microprocessors, or which may be a system on a chip integrated circuit, and the system also includes memory 1401 for storing data and programs for execution by the processing system. The system 1400 also includes an audio input/output subsystem 1405, which may include a microphone and a speaker for, for example, playing back music or providing telephone functionality through the speaker and microphone.

A display controller and display device 1409 provide a visual user interface for the user; this digital interface may include a graphical user interface which is similar to that shown on a Macintosh computer when running OS X operating system software, or Apple iPhone when running the iOS operating system, etc. The system 1400 also includes one or more wireless transceivers 1403 to communicate with another data processing system, such as the system 1400 of FIG. 14. A wireless transceiver may be a WLAN transceiver, an infrared transceiver, a Bluetooth transceiver, and/or a wireless cellular telephony transceiver. It will be appreciated that additional components, not shown, may also be part of the system 1400 in certain embodiments, and in certain embodiments fewer components than shown in FIG. 14 may also be used in a data processing system. The system 1400 further includes one or more communications ports 1417 to communicate with another data processing system, such as the system 1300 of FIG. 13. The communications port may be a USB port, Firewire port, Bluetooth interface, etc.

The data processing system 1400 also includes one or more input devices 1413, which are provided to allow a user to provide input to the system. These input devices may be a keypad or a keyboard or a touch panel or a multi touch panel. The data processing system 1400 also includes an optional input/output device 1415 which may be a connector for a dock. It will be appreciated that one or more buses, not shown, may be used to interconnect the various components as is well known in the art. The data processing system shown in FIG. 14 may be a handheld computer or a personal digital assistant (PDA), or a cellular telephone with PDA like functionality, or a handheld computer which includes a cellular telephone, or a media player, such as an iPod, or devices which combine aspects or functions of these devices, such as a media player combined with a PDA and a cellular telephone in one device or an embedded device or other consumer electronic devices. In other embodiments, the data processing system 1400 may be a network computer or an embedded processing device within another device, or other types of data processing systems, which have fewer components or perhaps more components than that shown in FIG. 14.

At least certain embodiments of the inventions may be part of a digital media player, such as a portable music and/or video media player, which may include a media processing system to present the media, a storage device to store the media and may further include a radio frequency (RF) transceiver (e.g., an RF transceiver for a cellular telephone) coupled with an antenna system and the media processing system. In certain embodiments, media stored on a remote storage device may be transmitted to the media player through the RF transceiver. The media may be, for example, one or more of music or other audio, still pictures, or motion pictures.

The portable media player may include a media selection device, such as a click wheel input device on an iPod® or iPod Nano® media player from Apple, Inc. of Cupertino, CA, a touch screen input device, pushbutton device, movable pointing input device or other input device. The media selection device may be used to select the media stored on the storage device and/or the remote storage device. The portable media player may, in at least certain embodiments, include a display device which is coupled to the media processing system to display titles or other indicators of media being selected through the input device and being presented, either through a speaker or earphone(s), or on the display device, or on both display device and a speaker or earphone(s). Examples of a portable media player are described in published U.S. Pat. No. 7,345,671 and U.S. published patent number 2004/0224638, both of which are incorporated herein by reference.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMS, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “determining,” “extracting,” “replacing,” “communicating,” “forwarding,” “retrieving,” “checking,” “allowing,” “rejecting,” “generating,” “confirming,” “constructing,” “comparing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A non-transitory machine-readable medium having executable instructions to cause one or more processing units to perform a method to forward an email from a provider registered to an identity management service to a user, the method comprising:
receiving an email, wherein the email includes: (1) a provider email address associated with the provider, the provider email address being a from email address and (2) an anonymized user email address associated with the user and provided by the identity management service, the anonymized user email address being a to email address;
extracting an anonymous user identifier from the anonymized user email address, wherein the anonymous user identifier is persistently associated with the user and at least one of the provider, an application of the provider, or a service of the provider;
retrieving, from a user table, a provider identifier using at least the anonymous user identifier of the anonymized user email address and the provider email address;
determining a replacement address for the provider email address using at least the provider identifier;
replacing the provider email address with the replacement address; and
forwarding the email to the user using the replacement address.

2. The non-transitory machine-readable medium of claim 1, wherein the method further comprises rejecting the email when a number of emails from the provider to the user exceeds a threshold.

3. The non-transitory machine-readable medium of claim 1, wherein the method further comprises receiving registration information from the provider, wherein the registration information includes a pattern of allowable email addresses.

4. The non-transitory machine-readable medium of claim 3, wherein the method further comprises generating the provider identifier using at least the registration information.

5. The non-transitory machine-readable medium of claim 1, wherein the method further comprises:
receiving an indication of a user sign on with an application or service provided by the provider, wherein the user sign on includes user sign on information;
generating a user identifier using at least the user sign on information; and
associating a user identifier with the provider identifier;
wherein the provider receives an indication that the user is a real user, wherein the indication is part of the user sign on information.

6. The non-transitory machine-readable medium of claim 5, wherein the indication is determined based on a set of signals collected by a device associated with the user, and wherein the set of signals are at least one of mobility of the device, device usage, or a provider account history.

7. The non-transitory machine-readable medium of claim 1, wherein the anonymized user email address is generated from the anonymous user identifier.

8. A method to forward an email from a provider registered to an identity management service to a user, the method comprising:
receiving an email, wherein the email includes: (1) a provider email address associated with the provider, the provider email address being a from email address and (2) an anonymized user email address provided by the identity management service and associated with the user, the anonymized user email address being a to email address;
extracting an anonymous user identifier from the anonymized user email address, wherein the anonymous user identifier is persistently associated with the user and at least one of the provider, an application of the provider, or a service of the provider;
retrieving, from a user table, a provider identifier using at least the anonymous user identifier of the anonymized user email address and the provider email address;
determining a replacement address for the provider email address using at least the provider identifier;
replacing the provider email address with the replacement address; and
forwarding the email to the user using the replacement address.

9. The method of claim 8, further comprising rejecting the email when a number of emails from the provider to the user exceeds a threshold.

10. The method of claim 8, further comprising receiving registration information from the provider, wherein the registration information includes a pattern of allowable email addresses.

11. The method of claim 10, further comprising generating the provider identifier using at least the registration information.

12. The method of claim 8, further comprising:
receiving an indication of a user sign on with an application or service provided by the provider, wherein the user sign on includes user sign on information;
generating a user identifier using at least the user sign on information; and
associating a user identifier with the provider identifier;
wherein the provider receives an indication that the user is a real user, wherein the indication is part of the user sign on information.

13. The method of claim 12, wherein the indication is determined based on a set of signals collected by a device associated with the user, and wherein the set of signals are at least one of mobility of the device, device usage, or a provider account history.

14. The method of claim 8, wherein the anonymized user email address is generated from the anonymous user identifier.

15. A device comprising:
one or more memories; and
one or more processors communicatively coupled to the one or more memories and configured to execute instructions stored in the one or more memories for performing operations of:
receiving an email, wherein the email includes: (1) a provider email address associated with a provider, the provider email address being a from email address and (2) an anonymized user email address provided by an identity management service and associated with a user, the anonymized user email address being a to email address;
extracting an anonymous user identifier from the anonymized user email address, wherein the anonymous user identifier is persistently associated with the user and at least one of the provider, an application of the provider, or a service of the provider;
retrieving, from a user table, a provider identifier using at least the anonymous user identifier of the anonymized user email address and the provider email address;
determining a replacement address for the provider email address using at least the provider identifier;
replacing the provider email address with the replacement address; and
forwarding the email to the user using the replacement address.

16. The device of claim 15, wherein the operations further comprise rejecting the email when a number of emails from the provider to the user exceeds a threshold.

17. The device of claim 15, wherein the operations further comprise receiving registration information from the provider, wherein the registration information includes a pattern of allowable email addresses.

18. The device of claim 17, wherein the operations further comprise generating the provider identifier using at least the registration information.

19. The device of claim 15, wherein the operations further comprise:
receiving an indication of a user sign on with an application or service provided by the provider, wherein the user sign on includes user sign on information;
generating a user identifier using at least the user sign on information; and
associating a user identifier with the provider identifier;
wherein the provider receives an indication that the user is a real user, wherein the indication is part of the user sign on information.

20. The device of claim 19, wherein the indication is determined based on a set of signals collected by a user device, and wherein the set of signals are at least one of mobility of the device, device usage, or a provider account history.
